(19) United States
(12) Patent Application Publication
(10) Pub. No.: US 2025/0256950 A1
(43) Pub. Date: Aug. 14, 2025

(54) Mixing Beverage Concentrate in Cartridge

(71) Applicant: Heineken Supply Chain B.V., Amsterdam (NL)

(72) Inventors: Eric Richard Brouwer, Amsterdam (NL); Bart Jan Bax, Amsterdam (NL); Jeroen Frank Otto, Amsterdam (NL); Arie Maarten Paauwe, Amsterdam (NL)

(21) Appl. No.: 18/857,265

(22) PCT Filed: Apr. 19, 2023
(86) PCT No.: PCT/NL2023/050207

§ 371 Date: Oct. 16, 2024

(30) Foreign Application Priority Data
Apr. 19, 2022 (EP) 22168832.8

(51) Int. Cl. B67D 1/00

(52) U.S. Cl. CPC B67D 1/0078; B67D 1/0044; B67D 1/0057

(57) ABSTRACT

A cartridge is provided for use in a beverage dispenser for dispensing a post-mixed beverage. The cartridge comprises an expandable housing defining an internal volume for holding a liquid. The expandable housing can be manipulated from an unexpanded state to an expanded state. the internal volume is filled with a beverage concentrate, and the expandable housing is arranged to be further filled with a base liquid. such that a post-mixed beverage can be formed inside the internal volume from the beverage concentrate and the base liquid. By virtue of the cartridge. the use of a separate mixing chamber of a beverage dispenser may be avoided.

### TECHNICAL FIELD

The aspects and embodiments thereof relate to the field of forming and dispensing beverage formed by mixing a beverage concentrate with a base liquid.

### BACKGROUND

Beverages, such as soft drinks, beers, and cocktails are consumed at locations different from the location where they are produced. As such, the beverages have to be transported. In order to reduce the mass and volume to be transported, it has been suggested to concentrate the beverage—i.e. reduce the water content—prior to transport. The beverage concentrate may be diluted again to obtain the original beverage, with its original concentration, consistency and flavour, or a similar beverage, approximating the original concentration, consistency and flavour

A cartridge, otherwise referred to as container, pod, pouch, or capsule, may be used as a vessel for holding the beverage concentrate. A user may provide the cartridge to a beverage dispenser. The beverage concentrate is transported from the cartridge into a mixing chamber of the beverage dispenser, to be mixed with a base liquid such as water. The post-mixed beverage can be dispensed, for example in a glass.

Alternatively, beverage concentrate and a base liquid may be both be dispensed into a beverage container such as a glass. In such cases, the post-mixed beverage is formed in the beverage container.

### SUMMARY

It is an object to mix beverage concentrate with one or more base liquids, such that a substantially homogenous post-mixed beverage may be obtained. It may further be an object to dispense a post-mixed beverage, instead of dispensing beverage concentrate and base liquid subsequently or simultaneously into a beverage container to be mixed in the beverage container itself. This may for example improve the visual experience of a user viewing the stream of post-mixed beverage coming from the beverage dispenser—similar to a conventional beverage dispenser for dispensing conventional non-post-mixed beverage.

Additionally or alternatively, mixing of ingredients forming the post-mixed beverage may be improved when the ingredients are mixed by the beverage dispenser, instead of dispensing the ingredients forming the post-mixed beverage individually into a beverage container to be mixed in the beverage container itself. Furthermore, mixing by the beverage dispenser may offer improved control of the mixing process, compared to dispensing the ingredients forming the post-mixed beverage individually into a beverage container to be mixed in the beverage container itself.

A first aspect provides a cartridge for use in a beverage dispenser for dispensing a post-mixed beverage, the cartridge comprising an expandable housing defining at least part of an internal volume, in particular for holding a liquid. The expandable housing can be manipulated from an unexpanded state to an expanded state. In the unexpanded state, the internal volume of the cartridge may be filled with a beverage concentrate, and the expandable housing is arranged to be further filled with one or more base liquids, such that a post-mixed beverage can be formed inside the internal volume from the beverage concentrate and the one or more base liquids.

In general, the expandable housing is to be understood as the part of the cartridge arranged for holding or containing a fluid, in particular a liquid such as the beverage concentrate, base liquid, and/or a combination thereof. The housing may be formed as an integral part, or as a plurality of fluid-tightly connected parts. In general, the housing of the cartridge can be expandable in its entirety or only a part thereof can be expandable. The internal volume of the expandable housing is defined as the volume available for liquid in both the expandable part of the expandable housing and an optional non-expandable part of the expandable housing.

By virtue of being expandable from the unexpanded state to the expanded state, the expandable housing is arranged for holding different volumes of liquid—preferably essentially without any headspace such as air present in the internal volume. For example, in the unexpanded state, the expandable housing may only contain beverage concentrate—i.e. not contain any base liquid. By subsequently filling a volume of base liquid into the internal volume, the expandable housing can be manipulated to the expanded state, and the internal volume becomes filled with both the beverage concentrate and the base liquid.

The cartridge can hence be used as a mixing chamber of a beverage dispenser, and in particular no further mixing chamber may be required. Since the cartridge can be a disposable cartridge, the beverage dispenser optionally does not comprise a separate mixing chamber, which would otherwise come into contact with the beverage concentrate and would thus require cleaning.

The ratio between the internal volume in the unexpanded state and the expanded state may depend on a desired dilution factor between the beverage concentrate and the base liquid. For example, when a desired ratio is 1 part beverage concentrate on 4 parts base liquid, the internal volume in the expanded state may be 5 times larger than the internal volume in the unexpanded state. For example depending on the concentration factor of the beverage concentrate relative to the original beverage from which the beverage concentrate is made, per part beverage concentrate 3 or more, 4 or more, 5 or more, or even 6 or more equal parts of base liquid may be added.

For example, the preferred volume of post-mixed beverage to be dispensed may be 200 mL, 250 mL, 300 mL, 500 mL, or 568 mL (i.e. 1 pint). The preferred volume of post-mixed beverage may substantially correspond to the sum of the first volume of the beverage concentrate and the second volume of base liquid.

In general, the cartridge may comprise beverage concentrate for a single serving of post-mixed beverage. Alternatively, embodiments of cartridges are envisioned comprising a first volume of beverage concentrate which is sufficient for multiple servings of post-mixed beverage, for example 1 L, 2 L, 5 L or even 10 L or more of post-mixed beverage.

When the beverage concentrate and the base liquid are present in the same internal volume, mixing of the beverage concentrate and the base liquid into the post-mixed beverage can take place. Preferably, the beverage concentrate and the base liquid mix into an essentially homogenous post-mixed beverage prior to being dispensed, preferably inside the internal volume of the cartridge. The cartridge may be filled with more than one type of base liquid, originating from more than one source of base liquid. For example, water and ethanol may be mixed separately into the cartridge.

The beverage concentrate may be based on a fermented beverage, such as a beer, wine or a cider. The beverage concentrate may as such comprise a liquid such as water with particles dissolved and/or suspended therein. The beverage concentrate may hence be an aqueous liquid. The particles may be or comprise one or more proteins (proteinaceous material), sugars, organic compounds such as polyphenols, hop acids, and/or oxalates. As options, the beverage concentrate may be essentially free of ethanol or comprise a particular concentration of ethanol, such as 25% or less, 10% or less, 5% or less, or even 1% or less by volume. As a further option, the beverage concentrate may comprise dissolved carbon dioxide and/or any other gas such as nitrogen. A beverage concentrate based on a fermented beverage may be obtained by concentrating a fermented beverage, and/or by brewing a fermented beverage with a high concentration of flavouring agents. The high concentration of flavouring agents may be higher than a typical concentration of flavouring agents for said fermented beverage. For example, when the beverage concentrate comprises four times the flavouring agents per volume compared to a conventional beverage, the concentrate has to be diluted four times to obtain the desired concentration of flavouring agents. The high concentration of flavouring agent may result in a high dry matter content in the beverage concentrate, which is higher than a typical dry matter content in a conventional beverage.

The beverage concentrate may in general comprise one or more flavouring agents, for example aimed to mimic the flavour of another beverage. In particular, flavouring agents may be used to mimic the flavour of a fermented beverage, such as a beer, wine, or a cider. A flavouring agent may for example be an aromatic compound, an ester or an alcohol. By mixing one or more flavouring agent, in particular into an aqueous solution, a beverage concentrate may hence be obtained. It will thus be understood that a beverage concentrate may also be formed without a brewing or fermenting process.

In examples, the beverage concentrate may comprise or consist of solid particles. As such, the beverage concentrate may for example be a powder or tablet. The solid beverage concentrate can be dissolved, suspended, or dispersed into one or more base liquids. Multiple beverage concentrates may be used to form the post-mixed beverage, which multiple beverage concentrates may be in liquid and/or solid form.

As an option, the expandable housing comprises a foldable housing part. The foldable housing part may be folded out, in particular away from the internal volume, when the expandable housing is manipulated from the unexpanded state to the expanded state.

In general, the foldable housing part of the expandable housing may be formed as a bellow, arranged to be expanded to accommodate a larger volume of fluid in the internal volume. The larger volume may for example be caused by base liquid being pumped or sucked into the internal volume, and/or by beverage concentrate being pumped or sucked into the internal volume. A bellow may comprise a plurality of pleats arranged to fold relative to each other.

As a further option, at least part of the expandable housing comprises a stretchable material, arranged to stretch by virtue of a pressure difference between a pressure inside the internal volume and the pressure outside the expandable housing. For example, when a pressure inside the internal volume exceeds a pressure outside the expandable housing, the stretchable material stretches out and as such, the internal volume increases. The pressure inside the internal volume may for example be increased by virtue of a pump pumping base liquid into the internal volume.

An expandable housing comprising a stretchable material may function similar to a balloon, which when inflated accommodates a larger volume of fluid compared to a deflated state. When a pressure inside the internal volume equals a pressure outside the housing, and no external forces are applied to the housing, the stretchable part of the housing may be in a resting state—e.g. not elastically deformed.

In embodiments of the cartridge, the stretchable part of the expandable housing may be essentially undeformed in the unexpanded state or may be essentially undeformed in an emptied state. In the expanded state, the stretchable part may be elastically deformed—i.e. elastically stretched out.

After the beverage concentrate and the base liquid are at least partially mixed together in the internal volume of the cartridge to form the post-mixed beverage, the post-mixed beverage is to be expelled from the internal volume. To this end, for example, the expandable housing can further be manipulated into an emptied state, wherein the internal volume in the emptied state is smaller than the internal volume in the unexpanded state. In the emptied state, the internal volume may be near zero mL or at least below 10 mL or below 5 mL to prevent or reduce wasting the post-mixed beverage which may be left behind in the cartridge when the cartridge is discarded after use.

A gland may be connected to the housing adjacent to the internal volume. The gland may for example be a filling gland, which is arranged for corporation with a filling machine for filling the cartridge with beverage concentrate.

Embodiments of the cartridge may comprise an outlet spout extending from the expandable housing, which outlet spout comprises an outlet end in fluid communication with the internal volume. In use, post-mixed beverage formed in the internal volume of the cartridge by adding base liquid to the beverage concentrate may be dispensed into a beverage container via the outlet spout. A beverage container may for example be a glass, a bottle, a growler, or a cup. The spout may hence be used to guide the beverage concentrate to a particular component of the beverage dispenser, or into a glass of a consumer. The filter may be positioned inside the spout, upstream of the spout, or downstream of the spout.

The outlet spout may be disposable, for example together with the cartridge. Preferably, the post-mixed beverage is directly transferred from the internal volume of the cartridge into the beverage container without contacting parts of a beverage dispenser. This may prevent or reduce a need for cleaning the beverage dispenser and/or contamination of the dispensed post-mixed beverage with a previously dispensed beverage.

A restriction member may be provided for temporarily holding the expandable housing in the unexpanded state. When the cartridge is in the unexpanded state, the cartridge may be filled with the beverage concentrate, in particular only with the beverage concentrate. In this state, the cartridge may be transported, for example from a filling plant to a point of use where a suitable beverage dispenser is provided. During transport and before use, it may be preferred to prevent or at least reduce the chance of the expandable housing from being manipulated into the expanded state. The restriction member may thus be arranged to temporarily hold the expandable housing in the unexpanded state.

The restriction member may for example be releasably attached to the cartridge, and may for example be released by a user. The restriction member may be arranged to release when subjected to a force and/or pressure above a particular threshold. This force and/or pressure may for example be supplied by a pump pumping base liquid into the internal volume of the expandable housing. The restriction member may be arranged to break or rip when subjected to a sufficient force, and may for example comprise one or more weakened sections arranged to break or rip when subjected to the sufficient force.

In embodiments, the cartridge may comprise a cartridge connector for connecting the cartridge to a receptacle connector of a beverage dispenser. A temporary connection between the cartridge and the beverage dispenser may be preferred to hold the cartridge in place while base liquid is pumped into the internal volume and/or when post-mixed beverage is expelled from the internal volume. The temporary connection may assist in maintaining a liquid-tight seal between the cartridge and the beverage dispenser.

As a particular option, embodiments of the cartridge may comprise an outer housing, and the expandable housing may be positioned at least partially inside the outer housing. The outer housing may protect the expandable housing for example from outside influences such as impacts. The outer housing may define at least part of the shape of the expandable housing in the unexpanded state and/or in the expanded state. When the cartridge comprises an outer housing, the cartridge may be or resemble a Bag-in-Container (BIC), Bag-in-Box or Bottle-in-Bottle (BIB).

The outer housing may be substantially rigid, in particular compared to the expandable housing. At least part of an outer shape of the outer housing remains substantially constant when the expandable housing is manipulated from the unexpanded state to the expanded state. In other words, at least part of or even the entire outer housing retains its shape and dimensions when the expandable housing is manipulated from the unexpanded state to the expanded state.

The outer housing may be used for dispensing the post-mixed beverage from the cartridge, for example by pressurizing a volume between the cartridge housing and the outer housing.

A second aspect provides a beverage dispenser assembly for dispensing a post-mixed beverage. The beverage dispenser assembly comprises a beverage dispenser, and a cartridge, in particular a cartridge according to the first aspect.

The beverage dispenser comprises a dispenser housing comprising a receptacle with a reception volume for receiving at least part of the cartridge. The beverage dispenser further comprises a base liquid input for receiving a base liquid, and a base liquid conduit fluidly connecting the base liquid input and the reception volume.

The receptacle of the beverage dispenser may be embodied as a hollow chamber in the dispenser housing. In general, the receptacle may be arranged for receiving at least a part of the cartridge, or the entire cartridge. The receptacle may be temporarily closed off or sealed with an optional lid, hatch, or other closing element. For example, while base liquid is pumped into the cartridge, it may be preferred to fully surround the cartridge with the beverage dispenser. This may for example prevent a user from removing the cartridge during the filling of the cartridge, or during dispensing of the post-mixed beverage from the cartridge.

The base liquid input may for example be arranged to receive water as a base liquid. The water may be supplied from a separate water container, such as a bottle, or from a dedicated water container comprised by the beverage dispenser. Water may alternatively be supplied from a drinking water line. The base liquid may thus be or comprise water, optionally with other compounds such as ethanol, dinitrogen, and/or carbon dioxide dissolved in the water.

The beverage dispenser may comprise a cooling unit, for cooling the base liquid to a desired temperature which may correspond to a desired dispensing temperature for the post-mixed beverage, or a temperature below the desired dispensing temperature for the post-mixed beverage.

In use, a user may position a cartridge containing a first volume of beverage concentrate at least partially in the receptacle of the beverage dispenser to form a beverage dispenser assembly. At this time, the cartridge is in an unexpanded state, in which the cartridge is able to receive a second volume of base liquid into its internal volume.

To allow the cartridge to expand into the expanded state, the receptacle volume may have a first sub-volume for accommodating the cartridge filled with the first volume of beverage concentrate, and a second sub-volume adjacent to the first sub-volume. The first sub-volume and the second sub-volume together are arranged for accommodating the cartridge filled with the first volume of beverage concentrate and a second volume of base liquid. The first sub-volume of the receptacle volume may hence be equal to or larger than the first volume of beverage concentrate, and the first sub-volume and the second sub-volume of the receptacle volume together may be equal to or larger than the first volume of beverage concentrate plus the second volume of base liquid.

In embodiments of the beverage dispenser assembly, the beverage dispenser may comprise a receptacle connector, the cartridge may comprise a cartridge connector, and the cartridge connector may be releasably connected to the receptacle connector for fixing a position of the cartridge connector relative to the receptacle connector. By virtue of the cartridge connector and the receptacle connector, at least one liquid-tight seal may be achieved between the cartridge and the beverage dispenser. More than one liquid-tight seal may be achieved for example when a separate seal is required for supplying base liquid to the cartridge and for dispensing post-mixed beverage from the cartridge.

A releasable connection between the receptacle connector and the cartridge connector may for example be a clamped connection or a threaded connection.

The post-mixed beverage may preferably be dispensed as a carbonated beverage, for example when the post-mixed beverage is a beer, cider, or other fermented beverage. As such, the beverage dispenser may comprise a carbonator arranged for dissolving carbon dioxide into the base liquid or into the post-mixed beverage.

The carbonator may be arranged for carbonating base liquid passing through the base liquid conduit, and may for example be an in-line carbonator in the base liquid conduit. When the base liquid is carbonated when passing through the base liquid conduit, the base liquid is transferred into the internal volume of the cartridge as a carbonated base liquid. As an alternative, the carbonator may be arranged for carbonating the post-mixed beverage after the post-mixed beverage is expelled from the cartridge. Especially when the beverage concentrate comprises protein, it may be preferred to carbonate the base liquid prior to the mixing with beverage concentrate, to prevent excessive foaming. As a further alternative, the carbonator may be arranged for carbonating beverage concentrate inside the cartridge, prior to or during mixing with the one or more base liquids.

To improve and/or accelerate mixing of the beverage concentrate and the base liquid inside the cartridge, the beverage dispenser may further comprise an agitation unit for agitating a liquid inside the expandable capsule. For example, the agitation unit may be arranged for agitating the expandable capsule itself. Agitating may in general comprise shaking, rotating, swirling, or any other movement to improve mixing of beverage concentrate and base liquid inside the expandable capsule.

The cartridge may be manipulated from the expanded state to an emptied state, for example for expelling post-mixed beverage from the internal volume of the cartridge. The beverage dispenser may comprise an actuator for manipulating the cartridge from the expanded state to the emptied state, wherein in the emptied state, the internal volume in the housing of the cartridge is smaller than the first volume—i.e. the first volume of beverage concentrate with which the cartridge was previously filled.

The actuator may for example be an electric actuator, or a pneumatic actuator. In a particular example, the pneumatic actuator may be operated using pressurised carbon dioxide.

For transferring base liquid from the base liquid input of the beverage dispenser to the internal volume of the cartridge, the beverage dispenser may further comprise a pump. The pump may provide sufficiently pressurised base liquid into the internal volume of the cartridge to manipulate the cartridge from the unexpanded state into the expanded state.

As an option, the pump may be used to suck out post-mixed beverage formed by post-mixed beverage concentrate and base liquid from the internal volume of the cartridge. As such, the pump may be used as an actuator for manipulating the cartridge from an expanded state to an emptied state.

A third aspect provides a method of dispensing a post-mixed beverage. The method comprises providing a cartridge filled with a first volume of beverage concentrate to a beverage dispenser or receiving a cartridge filled with a first volume of beverage concentrate by a beverage dispenser, using the beverage dispenser, feeding a second volume of base liquid into the cartridge, such that the fluid volume inside the cartridge, in particular an internal volume of the cartridge, at least equals the sum of the first volume and the second volume, allowing the beverage concentrate and the base liquid to become at least partially mixed inside the cartridge, to form a post-mixed beverage, and dispensing the post-mixed beverage from the cartridge.

The method thus allows the post-mixed beverage to become mixed inside the cartridge. This may prevent the need of a separate mixing chamber.

In particular when the cartridge is discarded after the dispensing of the post-mixed beverage from the cartridge, cleaning of a separate mixing chamber may thus not be necessary.

Optional features disclosed in conjunction with the cartridge according to the first aspect may be readily applied to the beverage dispenser assembly according to the second aspect and the method according to the third aspect.

### BRIEF DESCRIPTION OF THE FIGURES

FIG. 1 shows a schematic view of an embodiment of a beverage dispenser assembly;

FIGS. 2A-2D schematically show different embodiments of a cartridge;

In FIGS. 3A-3C, a generic embodiment of an expandable cartridge is depicted;

FIGS. 4A and 4B schematically depict a section view of a receptacle of a beverage dispenser;

FIGS. 5A, 5B and 5C depict yet another embodiment of a cartridge;

FIG. 6 schematically shows a beverage dispenser assembly;

FIG. 7A schematically depicts an embodiment of a cartridge comprising a filter; and

FIG. 7B schematically shows an example of beverage dispensing assembly.

### DETAILED DESCRIPTION OF THE FIGURES

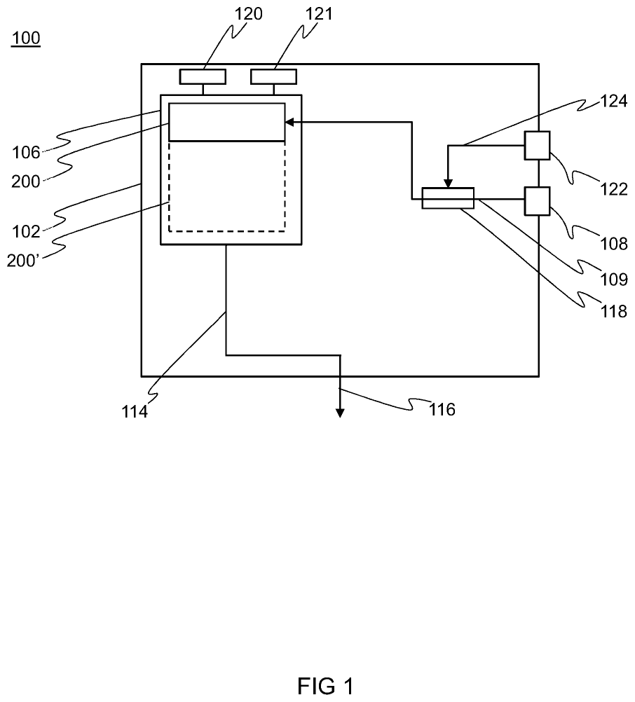

FIG. 1 shows a schematic view of an embodiment of a beverage dispenser assembly 100. The beverage dispenser assembly 100 comprises a beverage dispenser 102, which for example may be a table-top dispenser for consumer use.

The beverage dispenser 102 comprises a receptacle 106 with a reception volume in which a cartridge 200 is positioned. The cartridge 200 holds a volume of beverage concentrate. The beverage dispenser 102 further comprises a base liquid input 108 for receiving a base liquid. The base liquid input 108 may for example be connectable to a base liquid source, such as a faucet supplying tap water or a container comprised by the beverage dispenser.

A carbonator 118 may be comprised by the beverage dispenser 102, to form a carbonated base liquid. The carbonator 118 may for example be positioned in-line with a base liquid conduit 109. To provide a gas such as CO2 to the carbonator 118, the beverage dispenser 102 comprises a gas inlet 122 and a gas conduit 124 for transporting gas from the gas inlet 122 to the carbonator 118.

For expelling the beverage concentrate from the cartridge 200, the beverage dispenser 102 comprises an expelling actuator 120. The expelling actuator 120 may for example be arranged to be moved towards the cartridge 200, and in particular squeeze, collapse, fold and/or crush the cartridge 200 into the emptied state. Alternatively, or additionally, the expelling actuator 120 may be arranged to suck post-mixed beverage from the cartridge 200, which may cause the cartridge 200 to become collapsed or folded into the emptied state.

The cartridge 200 holding the beverage concentrate is an expandable cartridge. Using an expandable cartridge may eliminate the need for a separate mixing chamber. In FIG. 1, the cartridge 200 is shown in an unexpanded state with a solid line, and in an expanded state with the dashed line 200′.

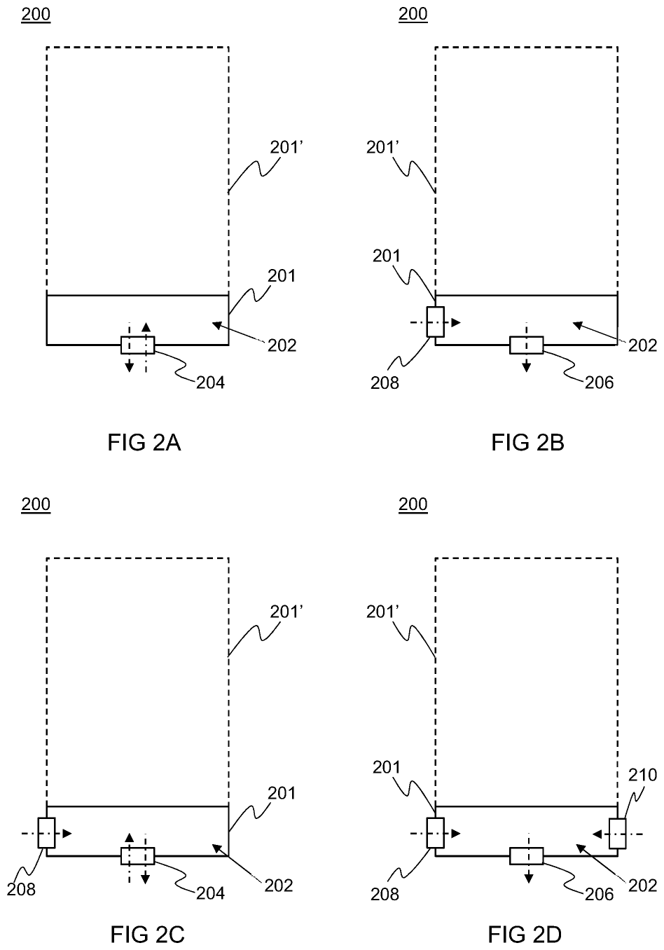

Instead of using a separate mixing chamber, or mixing beverage concentrate and base liquid in a beverage container such as a glass, in the embodiment of FIG. 1, the cartridge 200 is used as a mixing chamber in which the post-mixed beverage is formed by mixing beverage concentrate and base liquid. To this end, the base liquid input 108 is in fluid communication with the receptacle 106 in which the cartridge 200 is positioned to supply base liquid to the cartridge 200, for example to a fluid passage of the cartridge 200 as will be elucidated in conjunction with FIGS. 2A-2D.

A post-mixed beverage conduit 114 is positioned in fluid communication with the receptacle 106, to receive post-mixed beverage from the cartridge 200. Via the post-mixed beverage conduit 114, the post-mixed beverage can be dispensed through the dispensing outlet 116 at a downstream end of the post-mixed beverage conduit 114. The post-mixed beverage conduit 114 may be comprised by the beverage dispenser 102, or by the cartridge 200. The post-mixed beverage conduit 114 may at least partially be a flexible conduit, in particular when comprised by the cartridge 200 to allow a user to correctly position the post-mixed beverage conduit 114 relative to the beverage dispenser 102. Alternatively, the post-mixed beverage conduit 114 may be a rigid conduit, for example a rigid outlet spout comprised by the cartridge 200.

As an option schematically shown in FIG. 1, the beverage dispenser 102 may comprise an optional agitation unit 121. The agitation unit 121 is generally arranged for agitating a liquid inside the cartridge.

FIGS. 2A-2D schematically show different embodiments of a cartridge 200, wherein the cartridge in unexpanded state is depicted with a solid line, and the expanded state is indicated with a dashed line 201′, which can partially overlap the solid line. In FIGS. 2A-2D, different options are depicted by which liquids can be transported into and out of the internal volume 202 of the cartridge 200. It will be understood that these different options may be applied to any embodiment of the cartridge 200 disclosed herein.

In general, for a cartridge, it may be required that the internal volume can be first filled with a volume of beverage concentrate, for example at a filling plant. Next, the internal volume is further filled with a volume of base liquid, for example by a beverage dispenser at a consumer's home or at a commercial location such as a bar, increasing the internal volume of the cartridge. As such, a post-mixed beverage is formed in the internal volume, which post-mixed beverage comprises the base liquid and the beverage concentrate. Finally, the internal volume has to be at least partially emptied, by expelling the post-mixed beverage from the internal volume. It is hence understood that the cartridge may comprise one or more fluid inlets and one or more fluid outlets, wherein in particular embodiments a fluid inlet may also be used as a fluid outlet.

In the embodiment of FIG. 2A, the cartridge 200 comprises a single fluid passage 204 into the internal volume 202. The single fluid passage 204 is used as a fluid inlet for allowing the internal volume 202 to be filled with the volume of beverage concentrate and the volume of base liquid. The single fluid passage 204 is also used as a fluid outlet, for allowing post-mixed beverage to flow out of the internal volume 202. In the figures, the possible directions of fluid passing through the passages is generally indicated by dash-dotted arrows.

In the embodiment of FIG. 2B, the cartridge 200 comprises a fluid inlet 208 allowing the internal volume 202 to be filled with the volume of beverage concentrate and the volume of base liquid. The cartridge 200 further comprises a fluid outlet 206 allowing post-mixed beverage to flow out of the internal volume 202. When a fluid passage is used only as a fluid inlet or only as a fluid outlet, in particular a one-way valve may be present in the fluid passage which restricts passage of fluid in one direction, while allowing passage of the fluid in the opposite direction. A particular pressure differential over the one-way valve may be required for opening the one-way valve. The one-way valve may for example be an umbrella valve or duckbill valve.

In the embodiment of FIG. 2C, the cartridge 200 comprises a fluid inlet 208 allowing the internal volume 202 to be filled with a first of the volume of beverage concentrate and the volume of base liquid. The cartridge 200 further comprises the fluid passage 204, which is used to allow the internal volume 202 to be filled with the second of the volume of beverage concentrate and the volume of base liquid. The fluid passage 204 is also used as a fluid outlet, for allowing post-mixed beverage to flow out of the internal volume 202.

As such, the fluid inlet 208 may be a dedicated fluid inlet 208 for filling the internal volume either with the beverage concentrate, or with the base liquid. As such, the fluid inlet 208 may be designed to be compatible with a filling machine at the filling plant or with the beverage dispenser for dispensing the post-mixed beverage. When the fluid inlet 208 is designed to be compatible with the filling machine at the filling plant, the fluid passage 204 may be designed to be compatible with the beverage dispenser.

In the embodiment of FIG. 2D, the cartridge 200 comprises a beverage concentrate inlet 208 for receiving the volume of beverage concentrate into the internal volume 202. The cartridge 200 further comprises a base liquid inlet 210 separate from the beverage concentrate inlet 208, for receiving the volume of base liquid into the internal volume 202. The cartridge 200 also comprises a separate fluid outlet 206, for allowing post-mixed beverage to flow out of the internal volume 202.

In general, when the cartridge 200 comprises a substantially rigid, non-expandable housing part, the one or more fluid inlets and/or the one or more fluid outlets may be provided by or through the non-expandable housing part. As such, when the cartridge 200 is manipulated from the unexpanded state to the expanded state, the position and/or orientation of the one or more fluid inlets and/or the one or more fluid outlets may remain unchanged relative to the receptacle of the beverage dispenser. Alternatively, the one or more fluid inlets and/or the one or more fluid outlets may be provided by or through an expandable housing part. For example, a fluid inlet with which the cartridge is filled with beverage concentrate may be provided by or through an expandable housing part.

In FIGS. 3A-3C, a generic embodiment of an expandable cartridge 200 is depicted, respectively in an unexpanded state, in an expanded state, and in an emptied state. The expandable cartridge 200 comprises an expandable housing 201 defining an internal volume 202 for holding a liquid, such as a beverage or beverage component.

For example, in the unexpanded state, the internal volume 202 may be between 30 mL and 150 mL, or may even be larger than 150 mL, even larger than 500 mL or larger than 1000 mL, and is filled with beverage concentrate. In the expanded state, the internal volume 202 may be between 250 mL and 500 mL, or even between 500 mL and 2500 mL, or even larger than 2500 mL or even larger than 5000 mL, and is filled with beverage concentrate and base liquid. In the emptied state, the internal volume 202 may be less than 30 mL, less than 10 mL, or even approximately 0 mL, such that no or essentially no beverage is left behind in the cartridge 200. The ratio between the internal volume 202 in the unexpanded state and the internal volume 202 in the expanded may depend on a desired mixing ratio between the beverage concentrate and the base liquid. The volumes disclosed in this paragraph may be generally applied to any other embodiment of the cartridge 200 disclosed herein.

The base liquid is added to the cartridge 200 using the beverage dispenser 100. The beverage dispenser 100 may comprise a controller, arranged to control the volume of base liquid added into the cartridge 200. The beverage dispenser 100 may for example comprise a pump for pumping base liquid into the cartridge 200, and a sensor for determining a volume of base liquid pumped into the cartridge 200, such as a flow sensor.

As an option, the beverage dispenser 100 may be arranged for filling different cartridges 200 with different volumes of base liquid, or even with a different base liquid dependent on the beverage concentrate inside the cartridge. For example, for one beverage concentrate, the desired base liquid may be water, whilst for another beverage concentrate, the desired base liquid may be carbonated water.

In general, a cartridge may be provided with a machine-readable medium, such as a barcode, QR-code, RFID tag, or any other medium, from which a sensor of the beverage dispenser may read data relating to the cartridge. This data may for example related to a desired volume of base liquid to be added to the cartridge and/or a type of base liquid to be added to the cartridge.

In the example of FIGS. 3A-3C, the cartridge 200 comprises a foldable housing part 230 as at least part of an expandable housing, formed as a bellow comprising a plurality of pleats 231. Between the unexpanded state shown in FIG. 3A, and the expanded state shown in FIG. 3B, the foldable housing part 230 is generally folded out away from the internal volume 202.

In other words, the foldable housing part 230 generally expands outward. The expansion is permitted by virtue of the pleats folding open, when the cartridge is for example filled with a volume of base liquid.

The foldable housing part 230 may be elastically and/or plastically deformed when the expandable housing is manipulated from the unexpanded state to the expanded state.

The foldable housing part 230 may also at least partially allow the cartridge 200 to be manipulated from the expanded state, as shown in FIG. 3B, to the emptied state, as shown in FIG. 3C. For example, at least part of the expandable housing 201 may be moved towards the internal volume 202, in other words generally inwards towards itself. For example, the pleats 231 may fold when the expandable housing 201 is manipulated into the emptied state.

The foldable housing part 230 as shown in FIGS. 3A-3C may be readily used in conjunction with any embodiment of the cartridge disclosed herein, for example any embodiment disclosed in conjunction with FIGS. 2A-2D.

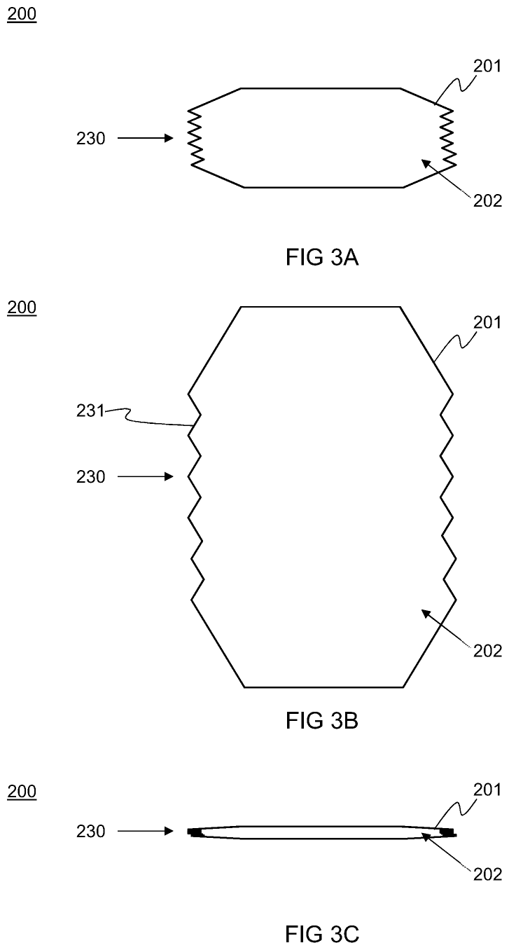

FIGS. 4A and 4B schematically depict a section view of a receptacle 106 of a beverage dispenser. The receptacle 106 has a reception volume 107 for receiving at least part of the cartridge 202. In general, a receptacle 106 may in use form a closed volume. The volume may be accessible through an opening of the receptacle 106, which may in use be closed off by a lid. In FIGS. 4A and 4B, for conciseness of the figures, the lid is omitted. It will be appreciated that the receptacle 106 shown in FIGS. 4A and 4B may also be used in conjunction with other embodiments of the cartridge 200.

The opening of the receptacle may be arranged for allowing passage of at least part of the cartridge 200 into the reception volume 107, only when the cartridge is in the unexpanded state, or also when the cartridge is in the expanded state.

In FIGS. 4A and 4B, a particular embodiment of a cartridge 200 is shown positioned inside the receptacle 106. The cartridge 200 comprise an expandable housing 201 which comprises a stretchable material, arranged to stretch by virtue of a pressure difference between a pressure inside the internal volume 202 and a pressure outside the expandable housing 201. The expandable housing 201 with the stretchable material may mimic a balloon, which is inflatable with a fluid such as a liquid or a gas.

The pressure outside the expandable housing 201 may correspond to ambient pressure, or may even be lower than ambient pressure. The pressure inside the internal volume 202 may be higher than the pressure outside the expandable housing 201 by virtue of a liquid entering the internal volume 202, which liquid is subjected to a higher pressure. The higher pressure may for example be provide by a pump, for example a pump pumping base liquid into the internal volume 202.

The cartridge 200 is in FIG. 4A shown in an unexpanded state, wherein the internal volume 202 is filled with a beverage concentrate. In FIG. 4B, the cartridge 200 is shown in an expanded state, after the internal volume 202 has been filled with and expanded by a volume of base liquid. As such, in the state of FIG. 4B, the internal volume 202 is filled with both the beverage concentrate and the base liquid, which may mix together inside the cartridge 200 to form the post-mixed beverage. The reception volume 107 of the receptacle may be larger than the internal volume 202 of the cartridge 200 in the expanded state. As such, parts of the cartridge 200 other than the internal volume 202 may be accommodated, and/or cartridge 200 with different volumes may be used with a single receptacle. The outer shape of the cartridge 200 may be restricted by the shape of the reception volume 107 of the receptacle.

A further option depicted in FIGS. 4A and 4B is that the cartridge 200 may comprise a cartridge connector 240 for temporarily connecting the cartridge to a receptacle connector 142 comprised by the beverage dispenser, in particular by the receptacle 106. The receptacle connector 142 may be provided by the receptacle, or by an optional lid for closing off the reception volume of the receptacle.

In general, the connection between the cartridge connector 240 and the receptacle connector 142 may be a clamped connection, a threaded connection, a bayonet connection, a form-closed connection, a latched connection, or any other temporary connection. By virtue of the connection between the cartridge connector 240 and the receptacle connector 142, the cartridge 200 may be kept in place in particular when the base liquid is added into the cartridge 200, and/or the post-mixed beverage is expelled from the cartridge 200.

Preferably, the cartridge connector 240 is a rigid body. The cartridge connector 240 may be asymmetric, to allow the cartridge connector 240 to be oriented relative to the receptacle in only one orientation, or in a limited discrete number of orientations. This may for example ensure proper alignment of one or more fluid passages of the cartridge 200 with one or more fluid passages of the beverage dispenser. Asymmetry may for example be obtained by virtue of one or more notches, comprised by the cartridge connector 240 and/or the receptacle.

The connection between the cartridge connector 240 and the receptacle connector 142 may be made by a user providing the cartridge 200 to the beverage dispenser. Alternatively, the connection between the between the cartridge connector 240 and the receptacle connector 142 may be made by a connection actuator comprised by the beverage dispenser. The connection actuator may for example be an electric actuator or a pneumatic actuator. The connection actuator may be operated by the controller of the beverage dispenser, for example in response to detecting that a cartridge has been positioned in the reception volume of the receptacle, in response to the lid of the receptacle closing, and/or in response to a user input to a user interface of the beverage dispenser.

Although a single fluid passage 204 is depicted in FIGS. 4A and 4B, it will be understood that any of the fluid inlet and fluid outlet arrangements disclosed herein, in particular in conjunction with FIGS. 2A-2D, may be readily applied to the embodiment of the cartridge 200 shown in FIGS. 4A and 4B. The one or more fluid inlets and one or more fluid outlets may in particular be positioned through the receptacle connector 142.

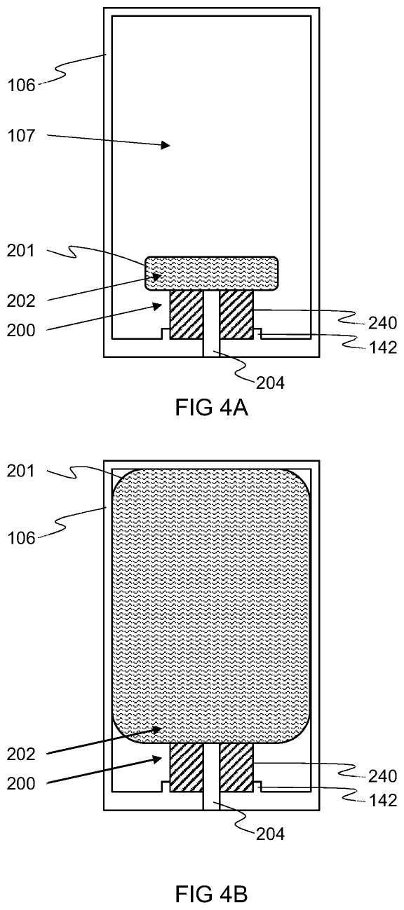

FIGS. 5A, 5B and 5C depict yet another embodiment of a cartridge 200, which particular embodiment comprises an outer housing 250. The expandable housing 201 with the internal volume 202 is positioned inside the outer housing 250. Respectively, in FIGS. 5A, 5B and 5C, the cartridge 200 is depicted in an unexpanded state, an expanded state, and an emptied state. The cartridge 200 is depicted comprising the optional cartridge connector 240.

To fill the cartridge 200 with base liquid, the fluid passage 204 is provided, in particular through the cartridge connector 240. Alternatively, and in general also for other embodiments of the cartridge 200, one or more fluid passages may be provided through the outer housing 250. It will be understood that any of the fluid inlet and fluid outlet arrangements disclosed herein, in particular in conjunction with FIGS. 2A-2D, may be readily applied to the embodiment of the cartridge 200 shown in FIGS. 5A, 5B and 5C.

The expandable housing 201 and the outer housing 250 function as a bag-in-container, wherein the expandable housing 201 expands inside the outer housing 250. The expansion of the expandable housing 201 may be restricted by the inner shape of the outer housing 250, as generally depicted in FIG. 5B. FIG. 5B shows the expandable housing 201 in the expanded state, filled with beverage concentrate and base liquid forming together the post-mixed beverage inside the cartridge 200.

To expel the post-mixed beverage from the cartridge 200, a fluid such as a gas may be pumped into a space between the outside of the expandable housing 201 and the inside of the outer housing 250. FIG. 5C shows the cartridge in an emptied state, wherein essentially all post-mixed beverage has been expelled from the expandable housing 201. The gas may for example be air or CO2. A gas passage 252 into the space between the outside of the expandable housing 201 and the inside of the outer housing 250 may be provided, for example through the cartridge connector 240.

It will be understood that the transition between the expanded state to the emptied state may be performed in a single dispensing action—thus serving a single beverage. Alternatively, the transition between the expanded state to the emptied state may be performed in multiple discrete dispensing actions—thus serving multiple volumes of beverage.

In the example shown in FIGS. 5A-5C, the shape of the outer housing remains substantially the same when the expandable housing is manipulated from the unexpanded state to the expanded state. In an alternative embodiment, the outer housing may be expandable as well. This may allow the volume occupied by the outer housing to be smaller when the expandable housing is only filled with the beverage concentrate-for example during transport and storage. The outer housing may be manipulated into an expandable state when the expandable housing is also manipulated into the expandable state. For example, the outer housing may comprise an expandable outer housing section and/or or comprise an elastic outer housing section.

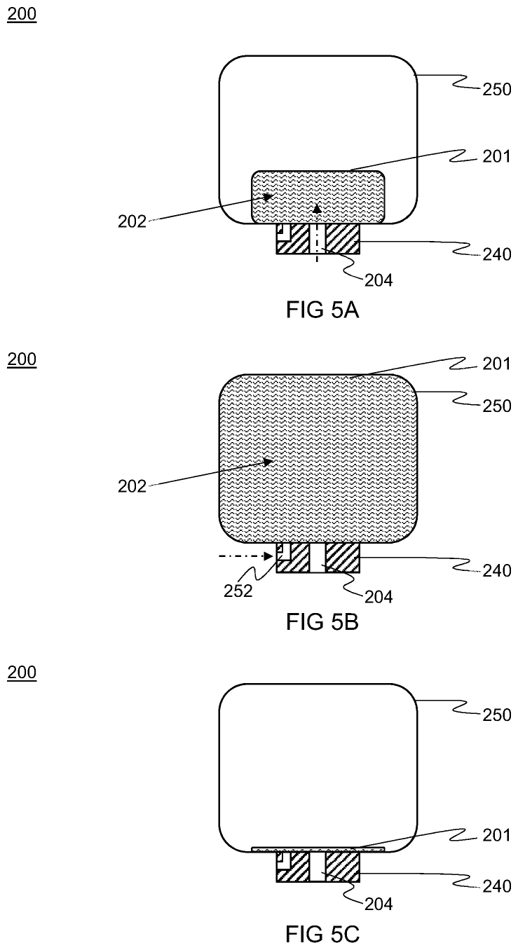

FIG. 6 schematically shows a beverage dispenser assembly 100, comprising an embodiment of a beverage dispenser 102 and an embodiment of a cartridge 200, shown in an unexpanded state as a solid line, and in an expanded state as a dashed line 200′ partially overlapping with the solid line, similar to for example FIGS. 2A-2D.

The beverage dispenser 102 comprises a dispenser housing 104 with the receptacle 106. The receptacle 106 provides the reception volume 107 in which the cartridge 200 is positioned.

The beverage dispenser 102 further comprises a water reservoir 160 which may be filled with a volume of water as an example of a base liquid. The water reservoir 160 has a filling opening 108 as a base liquid input for receiving the water as the base liquid into the water reservoir 160. Via a base liquid conduit 109, the base liquid can be transported to the cartridge 200 in the receptible 106, for example using a pump (not shown in the figure).

The embodiment of the cartridge 200 depicted in FIG. 6 comprises an optional outlet spout 162 extending away from the expandable housing 201. After the base liquid is pumped or sucked into the cartridge 200 and mixed together with the beverage concentrate, the post-mixed beverage may be expelled from the cartridge 200 through the spout 162. For example, the post-mixed beverage may be expelled into a glass 300.

The spout 162 may be disposable together with the cartridge 200. By virtue of the spout 162, direct contact between the beverage concentrate or the post-mixed beverage with the beverage dispenser 102 may be prevented or at least substantially reduced. This in turn may result in a lessened need of cleaning the beverage dispenser 102 and/or in improved hygiene.

The outlet spout 162 may be a filling gland connected to the cartridge 200 and used to fill the cartridge with beverage concentrate. The spout 162 may for example be glued or welded to the expandable housing 201. Alternatively, the spout 112 may be integrally formed with the expandable housing 201.

In general, the outlet spout 162 may be rigid. Alternatively, at least part of the spout 162 may be flexible, elastic, and/or resilient. This may allow the spout 162 to form a liquid-tight fit with the beverage dispenser, to prevent leakage of beverage concentrate. When at least part of the spout 162 is flexible, elastic, and/or resilient, the spout 162 may be used as a valve, in particular as a one-way valve. Additionally or alternatively, when at least part of the spout 162 is flexible, elastic, and/or resilient, the spout may be clamped or squeezed shut, and may as such act as an essentially liquid-tight seal.

For expelling the post-mixed beverage from the cartridge 200, the beverage dispenser 102 comprises an expelling actuator 120. The expelling actuator is arranged to squeeze post-mixed beverage out of the cartridge 200, such that the post-mixed beverage moves through the spout 162 into the glass 300.

Cartridge with filter

In general, any of the cartridges disclosed herein, in particular in conjunction with FIGS. 2A-5C, may comprise a filter designed for filtering suspended particles from beverage concentrate or post-mixed beverage passing through the filter. Filtering suspended particles may result in a post-mixed beverage with a lower turbidity.

Many different types of filters are envisioned. The filter may for example be a semi-permeable filter, such as a paper filter. In general, a semi-permeable filter may allow passage of a liquid, while blocking passage of solids by catching solids in the filter. Depending on the size of the solids, the solids may be caught in the filter, or when the solids are small enough, solids may pass through the filter. In particular when some solids are preferred to be present in the post-mixed beverage, the filter may be tuned to allow passage of these preferred solids, for example based on typical sizes of the preferred solids.

The filter may have an open-cell structure. For example, the filter may be a sintered filter, formed by sintering of a material such as a copper, stainless steel, any other metal, or a polymer. By virtue of the sintering process, an open-cell structure may be obtained for the filter. By virtue of the cell size of the open-cell structure, solid particles may become trapped while liquid is able to pass through the filter.

The filter may be embodied as a sieve with one or more pores. The pores may have a particular flow-through area or pore size, arranged to catch particles in the beverage concentrate, while allowing the liquid part to flow through the filter.

In embodiment, the pore size of the filter may be between 0.2-100 μm (micrometre). More in particular, the pore size of the filter may be between 0.3-50 μm, or even between 0.4-25 μm.

The filter may be formed as a sandwich construction, wherein a filter material is sandwiched between two sandwich plates. The filter material is arranged to catch suspended particles from a flow of beverage concentrate flowing through the filter. The filter material may for example have a granular form, such as diatomite, or kieselguhr, or may be a porous material such as porous ceramic or porous metal. The sandwich plates are arranged to hold the filter material in place between the sandwich plates. A flow of fluid is allowed through the sandwich plates, for example through openings or other passages through the sandwich plates. The openings or other passages are typically not arranged to catch particles suspended in the beverage concentrate.

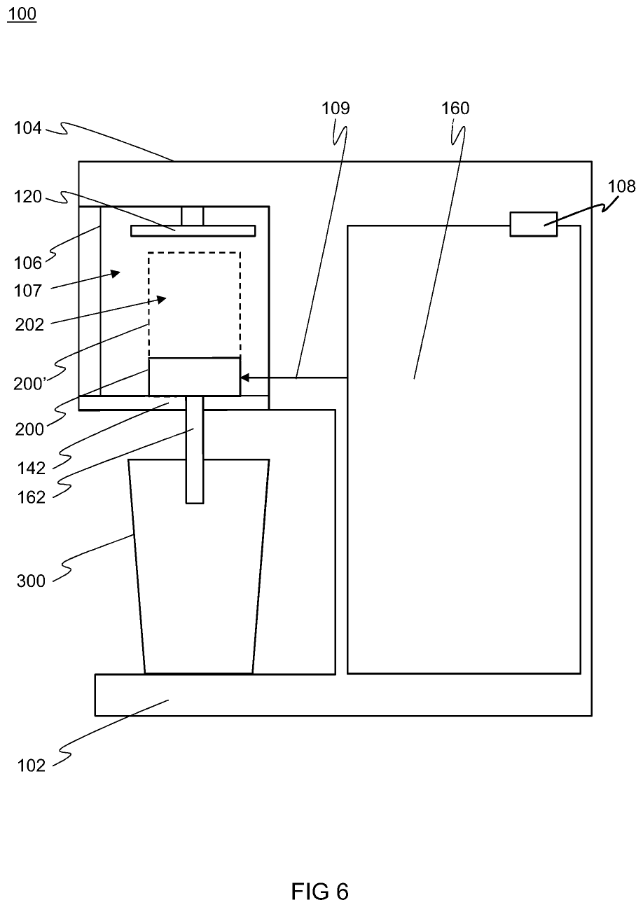

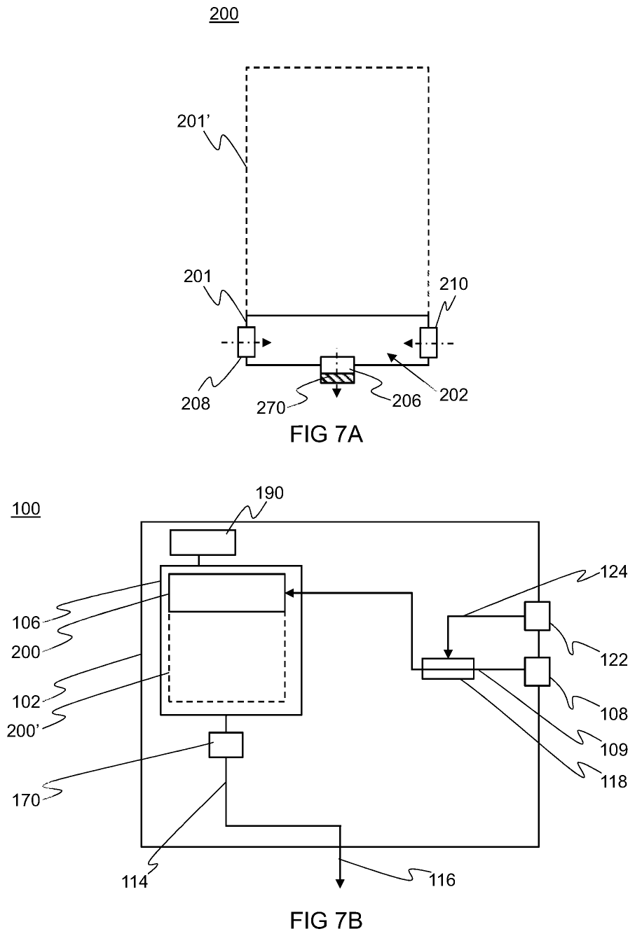

The filter may be comprised by the cartridge. FIG. 7A schematically depicts an embodiment of a cartridge 200 comprising a filter 270 (shown hatched) designed for filtering suspended particles from a beverage concentrate or post-mixed beverage passing from the internal volume through the filter 270.

Additionally or as an alternative to a filter comprised by the cartridge, a filter 170 may be comprised by the beverage dispenser assembly 100. This filter 170 may be positioned downstream of the reception volume 106—and in use downstream of the cartridge 100. For example, the filter 170 may be positioned in the post-mixed beverage conduit 114. FIG. 7B schematically shows an example of beverage dispensing assembly 200 with a beverage dispenser 102 comprising such as a filter.

### Cooling

As a further option depicted in FIG. 7B, which may be applied with or without the filter 170, embodiments of the beverage dispenser 102 may comprise a cooling unit 190 for withdrawing thermal energy from the reception volume 106. As such, the contents of the cartridge may be cooled. For example, beverage concentrate inside the cartridge may be cooled prior to adding the one or more base liquids into the cartridge. Additionally, or alternatively, after at least part of the one or more base liquids have been added into the cartridge, the post-mixed beverage formed inside the cartridge may be cooled by the cooling unit 190—prior to the post-mixed beverage being dispensed.

By cooling the beverage concentrate using the cooling unit of the beverage dispenser, the temperature of the beverage concentrate can be controlled. By being able to control the temperature of the beverage concentrate, the temperature of the dispensed post-mixed beverage can be controlled better, in particular when the temperature of the base liquid or base liquids can be controlled as well by the beverage dispenser. In particular, the temperature of the dispensed post-mixed beverage may become less dependent or even independent of the temperature of the cartridge when received by the beverage dispenser.

By cooling post-mixed beverage formed inside the cartridge, the shelf life of post-mixed beverage may be increased, and the post-mixed beverage may be dispensed over a larger amount of time with reduced reduction in quality. Furthermore, cooling the cartridge by the beverage dispenser may allow post-mixed beverage may be dispensed on demand at a preferred temperature, for example below 10 degrees C., below 6 degrees C., or even below 2 degrees C.

The cooling unit of the beverage dispenser generally refers to any component of the beverage dispenser contributing to the process of cooling the beverage concentrate. For example, the cooling unit may comprise a thermoelectric cooler for cooling based on the Peltier effect. As another example, the cooling unit is arranged to cool based on vapour compression refrigeration. As such, the cooling unit may comprise one or more of a compressor, evaporator, condenser and expansion valve. A cooling fluid such as a cooling liquid such as water or glycol or a cooling gas such as CO2 may be used in the vapour compression refrigeration cycle.

Alternatively, the cooling unit is arranged to receive a cooled medium such as a cooled fluid, liquid, and/or gas cooled by an external cooling unit not comprised by the beverage dispenser. The cooled medium may be used by the cooling unit to withdraw thermal energy from the beverage concentrate.

The cooling unit may comprise one or more heat exchangers for withdrawing thermal energy from the cartridge. The cooling fluid may be circulated through the cooling unit and through the one or more heat exchangers. A heat exchanger may for example be a tube-in-tube heat exchanger.

In the description above, it will be understood that when an element is referred to as being connect to another element, the element is either directly connected to the other element, or intervening elements may also be present. Also, it will be understood that the values given in the description above, are given by way of example and that other values may be possible and/or may be strived for.

It is to be noted that the figures are only schematic representations of embodiments that are given by way of non-limiting examples. For the purpose of clarity and a concise description, features are described herein as part of the same or separate embodiments, however, it will be appreciated that the scope of the disclosure may include embodiments having combinations of all or some of the features described.

The word ‘comprising’ does not exclude the presence of other features or steps. Furthermore, the words ‘a’ and ‘an’ shall not be construed as limited to ‘only one’, but instead are used to mean ‘at least one’, and do not exclude a plurality.

1. A cartridge for use in a beverage dispenser for dispensing a post-mixed beverage, the cartridge comprising an expandable housing ) defining an internal volume, wherein:
the expandable housing can be manipulated from an unexpanded state to an expanded state;
in the unexpanded state, the internal volume is filled with a beverage concentrate; and
the expandable housing is arranged to be further filled with a base liquid, such that a post-mixed beverage can be formed inside the internal volume from the beverage concentrate and the base liquid.

2. The cartridge according to claim 1, wherein the expandable housing comprises a foldable housing part, and wherein the foldable housing part is folded out when the expandable housing is manipulated from the unexpanded state to the expanded state.

3. The cartridge according to claim 1, wherein at least part of the expandable housing comprises a stretchable material, arranged to stretch by virtue of a pressure difference between a pressure inside the internal volume and a pressure outside the expandable housing.

4. The cartridge according to claim 1, comprising a fluid outlet, and a fluid inlet into the housing for receiving a base liquid into the internal volume.

5. The cartridge according to claim 1, further comprising an outlet spout extending from the expandable housing, which outlet spout comprises an outlet end in fluid communication with the internal volume.

6. The cartridge according to claim 1, further comprising an outer housing, wherein the expandable housing is positioned inside the outer housing.

7. The cartridge according to any of the preceding claims claim 1, wherein the beverage concentrate is based on a fermented beverage, such as a beer.

8. A beverage dispenser assembly for dispensing a post-mixed beverage, the beverage dispenser assembly comprising a beverage dispenser and a cartridge, wherein:
the beverage dispenser comprises a dispenser housing comprising a receptacle with a reception volume for receiving at least part of the cartridge;
the beverage dispenser further comprises a base liquid input for receiving a base liquid, and a base liquid conduit fluidly connecting the base liquid input and the reception volume;
the cartridge comprises an expandable housing defining an internal volume and a first volume of beverage concentrate in the internal volume; and
the cartridge is at least partially positioned in the reception volume of the receptacle of the beverage dispenser.

9. The beverage dispenser assembly according to claim 8, wherein the reception volume has a first sub-volume for accommodating the cartridge filled with the first volume of beverage concentrate, and a second sub-volume adjacent to the first sub-volume, wherein the first sub-volume and the second sub-volume together are arranged for accommodating the cartridge filled with the first volume of beverage concentrate and a second volume of base liquid.

10. The beverage dispenser assembly according to claim 8, wherein the beverage dispenser further comprises a receptacle connector, the cartridge comprises a cartridge connector, and the cartridge connector is releasably connected to the receptacle connector for temporarily fixing a position of the cartridge connector relative to the receptacle connector.

11. The beverage dispenser assembly according to claim 8, wherein the beverage dispenser further comprises a carbonator for carbonating base liquid.

12. The beverage dispenser assembly according to claim 8, wherein the beverage dispenser further comprises an agitation unit for agitating a liquid inside the cartridge.

13. The beverage dispenser assembly according to claim 8, wherein the beverage dispenser further comprises a pump for pumping base liquid into the housing of the cartridge.

14. A method of dispensing a post-mixed beverage, comprising the steps of:
providing a cartridge filled with a first volume of beverage concentrate to a beverage dispenser or receiving a cartridge filled with a first volume of beverage concentrate by a beverage dispenser;
using the beverage dispenser, feeding a second volume of base liquid into the cartridge, such that the fluid volume in the cartridge at least equals the sum of the first volume and the second volume;
allowing the beverage concentrate and the base liquid to become at least partially mixed inside the cartridge, to form a post-mixed beverage; and
dispensing the post-mixed beverage from the cartridge.

15. The method according to claim 14, wherein the beverage concentrate is based on a fermented beverage.

16. The cartridge according to claim 6, wherein at least part of the outer housing retains its shape and dimensions when the expandable housing is manipulated from the unexpanded state to the expanded state.

17. The cartridge according to claim 7, wherein the fermented beverage is a beer.

18. The beverage dispenser assembly according to claim 8, wherein the cartridge is a cartridge according to claim 1.

19. The beverage dispenser assembly according to claim 11, wherein the carbonator is arranged for carbonating base liquid passing through the base liquid conduit.

20. The beverage dispenser assembly according to claim 8, wherein the beverage dispenser comprises an actuator for manipulating the cartridge from an expanded state to an emptied state, wherein in the emptied state, the internal volume in the housing of the cartridge is smaller than the first volume.
